(19) United States
(12) Patent Application Publication
(10) Pub. No.: US 2013/0091773 A1
(43) Pub. Date: Apr. 18, 2013

(54) POWER ACTUATED REAR GATE ARRANGEMENT

(71) Applicant: Audi AG, Ingolstadt (DE)

(72) Inventors: Jürgen Sendtner, Denkendorf-Zandt (DE); Franz Binder, Lenting (DE)

(73) Assignee: Audi AG, Ingolstadt (DE)

(21) Appl. No.: 13/650,543

(22) Filed: Oct. 12, 2012

(30) Foreign Application Priority Data
Oct. 15, 2011 (DE) 10 2011 116 205.8

(51) Int. Cl. E05F 15/00; B60J 5/10

(52) U.S. Cl. 49/324

(57) ABSTRACT

A power actuated rear gate arrangement for a vehicle includes at least one seat arranged in a rear area of the vehicle; a drive device for providing an external force, a rear gate which is pivotal between a closed position and an open position by the external force, detectors for detecting an occupation of the at least one seat, and control points for controlling the drive device, wherein the drive device is at least indirectly controllable from more than one of the control points, and wherein when the at least one seat is occupied less than all of the control points are authorized or activated for at least a pivoting of the rear gate from the open position to the closed position.

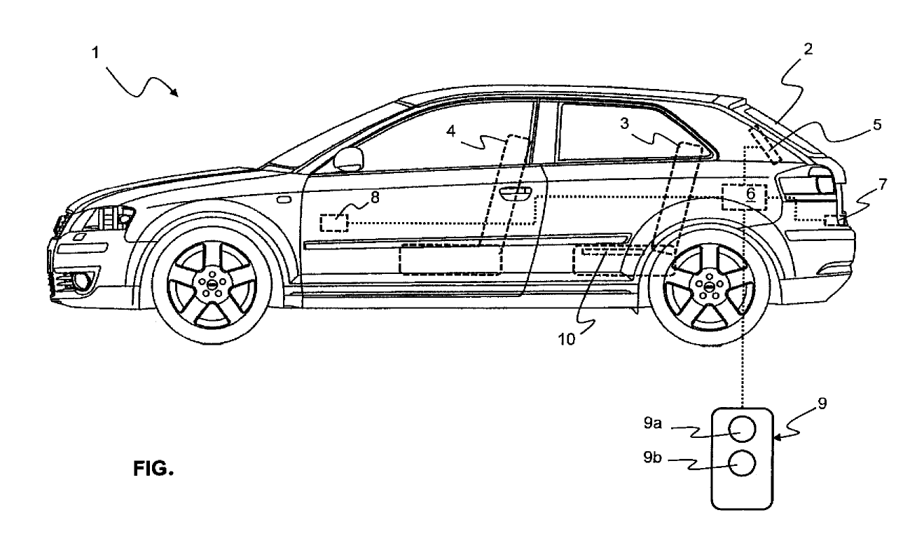

### CROSS-REFERENCES TO RELATED APPLICATIONS

This application claims the priority of German Patent Application, Serial No. 10 2011 116 205.8, filed Oct. 15, 2011, pursuant to 35 U.S.C. 119(a)-(d), the disclosure of which is incorporated herein by reference.

### BACKGROUND OF THE INVENTION

The present invention relates to a power actuated rear gate arrangement.

The following discussion of related art is provided to assist the reader in understanding the advantages of the invention, and is not to be construed as an admission that this related art is prior art to this invention.

Power actuated rear gate arrangements of this type are used in vehicle construction to optionally opening ort closing of a rear opening of the vehicle body in particular of a loading space or trunk by means of a rear gate. For this the rear gate is normally pivotal between an open position and a closed position about a pivot axis which extends horizontally in an upper region of the vehicle. To facilitate the actuation of the rear gate drive devices are increasingly used which provide an external force and thus take over this task from the user. The control of this drive device occurs indirectly or directly via one or more control points which are often configured as buttons. Rear gates of the generic type are for example disclosed in EP 2009 217 A1 or WO 2010/119080.

A disadvantage is that persons occupying the vehicle, in particular a rear area of the vehicle, may introduce limbs into the mechanic of the rear gate which in some cases can lead to severe injuries.

It would therefore be desirable and advantageous to provide a power actuated rear gate arrangement which counters the risk of pinching of limbs of persons occupying the vehicle

### SUMMARY OF THE INVENTION

According to one aspect of the present invention, a power actuated rear gate arrangement for a vehicle includes at least one seat arranged in a rear area of the vehicle, a drive device for providing an external force, a rear gate which is pivotal between a closed position and an open position by the external force, detectors for detecting an occupation of the at least one seat, and control points for controlling the drive device, wherein the drive device is at least indirectly controllable from more than one of the control points, and wherein when the at least one seat is occupied less than all of the control points are authorized or activated for at least a pivoting of the rear gate from the open position to the closed position.

Due to the fact that less than all of the control points remain authorized to initiate a closing process of the rear gate when a rear seat is occupied, wherein preferably only those control points are activated which allow for a safe closing of the rear gate, the risk of pinching for persons occupying the rear area of the vehicle can be significantly reduced. The vehicle can for example have any number of seats in a rear area, wherein all seats from which it is anatomically possible for a human to reach the rear gate should be monitored by the detectors. In particular, the focus is on seats which can be installed in a loading-space of the vehicle if needed because in this case there is a particularly close proximity to the rear gate hinges. Different sensors can be used as detectors which detect the mass and/or the volume of a person occupying the seat. The drive device can for example be configured as spindle drive. Although only the closing process, i.e., the movement of the rear gate from the open position to the closed position poses a particular pinching risk, the opening process, i.e., the movement of the rear gate from the closed position to the open position can also be carried out in dependence on the detectors in order to exclude any risk.

According to another advantageous feature of the invention, a control point can be configured as portable remote control. By means of a portable remote control the actuation of the rear gate can be initiated from a larger distance. The possible distance however, prevents sufficient supervision of the persons occupying the seats, so that the remote control should be deactivated for safety reasons when a rear seat is occupied.

According to another advantageous feature of the invention, a control point can be configured as a button on the rear gate. Preferably, the button can only be operated when the rear gate is in the open position and can therefore only initiate the closing process. Because a user is present in the vicinity of the rear gate during actuation, an observation of the persons occupying the rear area of the vehicle is in principal possible. In a preferred embodiment, only this control point is therefore authorized or activated when a rear seat is occupied.

According to another advantageous feature of the invention, a control point can be configured as a human-machine-interface which can be accessed from the driver seat. Suitable as human-machine-interface is a button in the door panel or a graphical user interface.

According to another advantageous feature of the invention, the control points can communicate with a control device which controls the drive device. The control device receives the incoming signals of all connected control points either wire based (button, infotainment system) or wirelessly (remote control) and processes the signals into an actuating command for the drive device.

According to another advantageous feature of the invention, the detectors can be configured as capacitive seat occupation sensors. Capacitive seat occupation sensors are often already available for seat belt engagement control and can therefore be easily used as detectors without additional costs.

According to another aspect of the present invention a vehicle includes a power actuated rear gate according to the invention and has multiple rear seats which are arranged in a seat row, wherein each seat has its own detector.

### BRIEF DESCRIPTION OF THE DRAWING

Other features and advantages of the present invention will be more readily apparent upon reading the following description of currently preferred exemplified embodiments of the invention with reference to the accompanying drawing, in which:

The sole FIGURE shows a schematic side view of a vehicle whit a power actuated rear gate arrangement.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the drawing there is shown a vehicle 1 which has a rear gate 2 which is arranged at the rear side of the vehicle and which is pivotal by an external force between a closed position (shown in the FIGURE) and an open position about a pivot axis which extends in the roof area. The external force is provided by a drive device 5, preferably a spindle drive. The drive device 5 is controlled by a control device 6. A seat 3 is arranged in a rear compartment of the vehicle 1. Located in the front part of the vehicle 1 are a driver seat 4 and a passenger seat, wherein here only the driver seat is shown. A human-machine-interface which can for example be configured as button in a door panel or as graphical user interface, is accessible from the driver seat 4. On the rear gate 2 a button 7 is arranged with which at least one closing process from the open position to the closed position can be initiated. In addition, a portable remote control 9 is provided which has an opening button 9a for opening the rear gate 2 and a closing button 9b for closing the rear gate 2. All control points 7, 8 and 9 control the drive device via the control device 6. In the rear seat 3 a seat occupation sensor 10 which can recognize whether a person is occupying the respective seat 3, is integrated into the seat surface. If no person is recognized to occupy the rear seat 3 the rear gate 2 can be closed from all control points 7, 8 or 9. If the seat occupation sensor recognizes the rear seat to be occupied by a person, a closing process of the rear gate 2 can only be initiated from the button 7 on the rear gate 2.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A power actuated rear gate arrangement for a vehicle, comprising:
at least one seat arranged in a rear area of the vehicle;
a drive device for providing an external force;
a rear gate which is pivotal between a closed position and an open position by the external force;
detectors for detecting an occupation of the at least one seat; and
control points for controlling the drive device, wherein the drive device is at least indirectly controllable from more than one of the control points, and wherein when the at least one seat is occupied less than all of the control points are authorized or activated for at least a pivoting of the rear gate from the open position to the closed position.

2. The power actuated rear gate arrangement of claim 1, wherein one of the control points is configured as portable remote control.

3. The power actuated rear gate arrangement of claim 1, wherein one of the control points is configured as a button disposed on the rear gate.

4. The power actuated rear gate arrangement of claim 1, wherein one of the control points is configured as a human-machine-interface which is accessible from a driver seat.

5. The power actuated rear gate arrangement of claim 3, wherein only the control point disposed on the rear gate is authorized when the at least one seat is occupied.

6. The power actuated rear gate arrangement of claim 1, further comprising a control device for controlling the drive device, wherein the control points are constructed for communication with the control device.

7. The power actuated rear gate arrangement of claim 1, wherein the detectors are configured as capacitive seat occupation sensors.

8. A vehicle comprising:
a power actuated rear gate arrangement which comprises at least one rear seat arranged in a rear area of the vehicle, a drive device for providing an external force, a rear gate which is pivotal between a closed position and an open position by the external force, detectors for detecting an occupation of the at least one rear seat, and control points for controlling the drive device, wherein the drive device is at least indirectly controllable from more than one of the control points, and wherein when the at least one rear seat is occupied less than all of the control points are authorized or activated for at least a pivoting of the rear gate from the open position to the closed position.

9. The vehicle of claim 8, further comprising multiple of said rear seat arranged in a seat row, wherein each of the multiple rear seats is provided with one of said detector.
